(19) United States
(12) Patent Application Publication
(10) Pub. No.: US 2018/0282100 A1
(43) Pub. Date: Oct. 4, 2018

(54) SHEET CONVEYANCE DEVICE, IMAGE FORMING APPARATUS, AND IMAGE READING APPARATUS

(71) Applicant: CANON KABUSHIKI KAISHA, Tokyo (JP)

(72) Inventors: Emi Machii, Izu-shi (JP); Tamotsu Kaneko, Mishima-shi (JP); Kazushi Suzuki, Suntou-gun (JP); Hideki Ohta, Numazu-shi (JP)

(21) Appl. No.: 15/909,731

(22) Filed: Mar. 1, 2018

(30) Foreign Application Priority Data
Mar. 31, 2017 (JP) 2017-070096

(51) Int. Cl. B65H 29/58; B65H 31/22; B65H 29/52; B65H 31/24; G03G 15/00; H04N 1/00

(52) U.S. Cl. CPC B65H 29/58; B65H 31/22; B65H 29/52; H04N 1/00631; G03G 15/602; G03G 15/6502; B65H 31/24

(57) ABSTRACT

A sheet conveyance device includes first and second discharge portions to discharge sheets, first and second stacking portions on which sheets are to be stacked, and a control unit to control the second stacking portion to move between a first position and a second position. The first position is that a downstream side of the second stacking portion is positioned and inclined upwardly with respect to an upstream side of the second stacking portion in a sheet conveyance direction of the sheets discharged from the second discharge portion. The second position is that the downstream side of the second stacking portion is positioned on a lower side of the first position of the downstream side of the second stacking portion.

### BACKGROUND OF THE INVENTION

### Field of the Invention

The present disclosure relates to a sheet conveyance device having a plurality of stacking portions for stacking discharged sheets, an image forming apparatus such as a copying machine, a facsimile machine, and a printer having the sheet conveyance device, and an image reading apparatus such as a scanner apparatus having the sheet conveyance device.

### Description of the Related Art

Conventionally, although downsizing of an apparatus main body of an image forming apparatus has been in progress, it has been often found that a sheet feeding tray or a sheet discharge tray projects from the apparatus main body in a state where sheets are stacked thereon. In consideration of distribution efficiency or a risk of breakage of the projecting portion, there is provided an image forming apparatus having a discharge tray or a sheet feeding tray which is foldable (see Japanese Patent Application Laid-Open No. 11-060016) or detachable (see Japanese Patent Application Laid-Open No. 2008-037528) during distribution or when it is not in use.

However, with the configuration illustrated in Japanese Patent Application Laid-Open No. 11-060016, there arises a jam at a discharge portion if the image forming apparatus is operated in a state where the discharge tray is closed. Therefore, a user has to issue a print signal after setting the discharge tray to a stacking state.

Further, according to the configuration illustrated in Japanese Patent Application Laid-Open No. 2008-037528, of the two discharge portions arranged one above the other, a discharge tray of the upper discharge portion is attachable to and detachable from the image forming apparatus. However, there is a possibility of jamming if discharge operation is executed while the discharge tray is attached. Further, if the image forming apparatus is operated in a state where the discharge tray is not attached to the upper discharge portion, printed materials stacked on the lower discharge tray are mixed with printed materials discharged from the upper discharge portion. Therefore, the user has to issue a print signal after attaching the discharge tray.

As described above, in the conventional configuration, because the user sets the discharge tray or performs jam processing before issuing a print signal, it will take unexpected time to acquire a printed material, and thus productivity thereof may be lowered considerably.

### SUMMARY OF THE INVENTION

The present disclosure is directed to a technique of preventing lowering of productivity while achieving downsizing of the apparatus.

According to an aspect of the present invention, a sheet conveyance device includes a first discharge portion configured to discharge sheets, a first stacking portion on which sheets discharged from the first discharge portion are to be stacked, a second stacking portion arranged on an upper side of the first discharge portion, on which sheets are to be stacked, a second discharge portion configured to discharge sheets to the second stacking portion, and a control unit configured to control the second stacking portion to move between a first position and a second position, wherein the first position is that a downstream side of the second stacking portion is positioned and inclined upwardly with respect to an upstream side of the second stacking portion in a sheet conveyance direction of the sheets discharged from the second discharge portion, and wherein the second position is that the downstream side of the second stacking portion is positioned on a lower side of the first position of the downstream side of the second stacking portion.

Further features of the present invention will become apparent from the following description of embodiments with reference to the attached drawings.

### BRIEF DESCRIPTION OF THE DRAWINGS

FIG. 1 is a main cross-sectional view of an image forming apparatus according to a first embodiment.

FIG. 2 is a main cross-sectional view of the image forming apparatus according to the first embodiment.

FIG. 3 is a top plan view of the image forming apparatus according to the first embodiment.

FIG. 4 is a main cross-sectional view of an image forming apparatus according to a second embodiment.

FIG. 5 a main cross-sectional view of the image forming apparatus according to the second embodiment.

FIG. 6 is a top plan view of the image forming apparatus according to the second embodiment.

FIG. 7 is a main cross-sectional view of an image forming apparatus according to a third embodiment.

FIG. 8 is a main cross-sectional view of the image forming apparatus according to the third embodiment.

FIG. 9 is a main cross-sectional view of an image forming apparatus according to a fourth embodiment.

FIG. 10 is a main cross-sectional view of the image forming apparatus according to the fourth embodiment.

FIG. 11 a top plan view of the image forming apparatus according to the fourth embodiment.

### DESCRIPTION OF THE EMBODIMENTS

Hereinafter, embodiments will be described in detail with reference to the appended drawings. However, sizes, materials, shapes, and relative positions of constituent elements described in the embodiments described below are not intended to limit the scope of the present disclosure, and should be changed as appropriate according to a configuration or various conditions of an apparatus to which the present disclosure is applied.

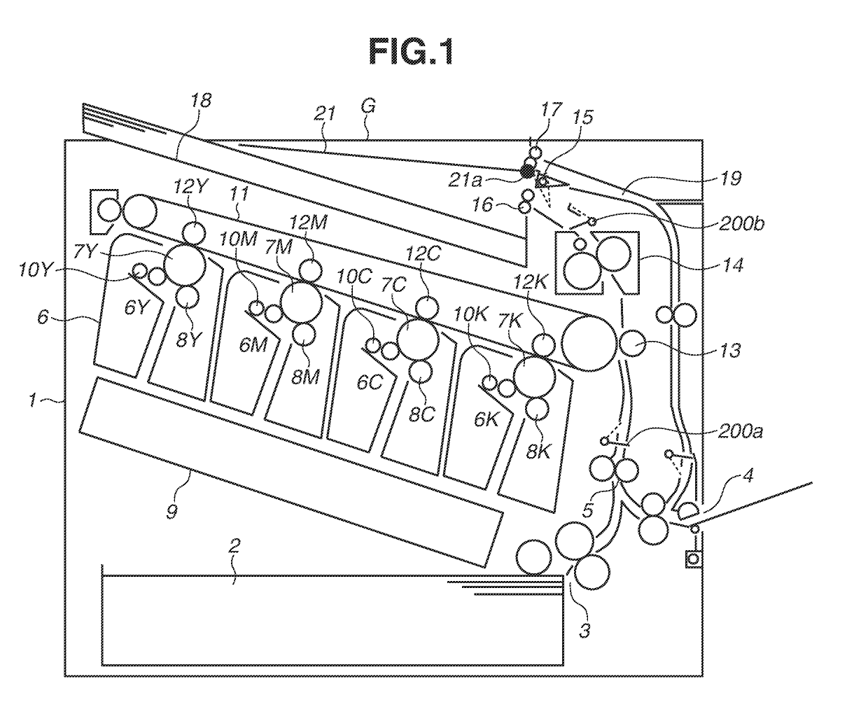

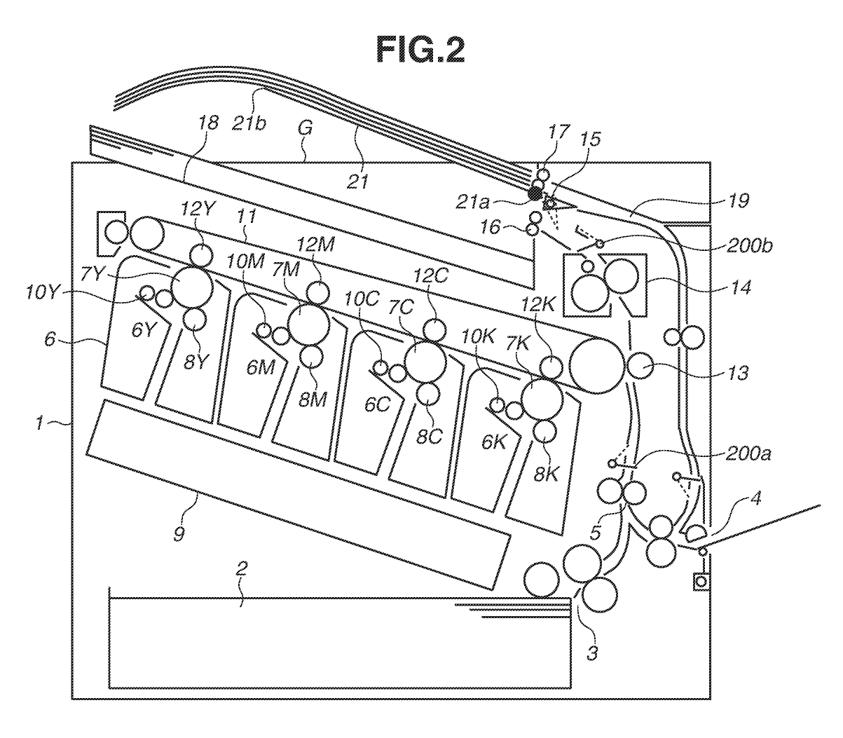

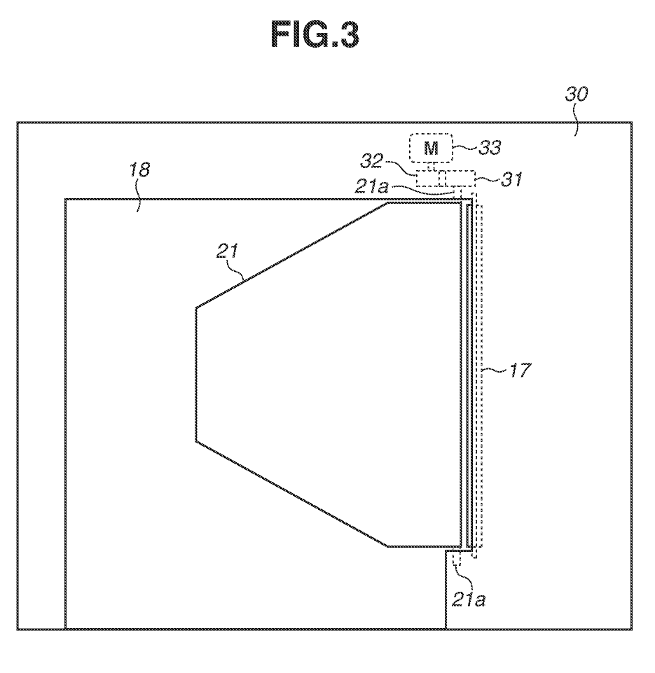

An image forming apparatus 1 including a sheet conveyance device according to a first embodiment will be described with reference to FIGS. 1 to 3. FIGS. 1 and 2 are main cross-sectional views illustrating a general configuration of the image forming apparatus 1. FIG. 3 is a top plan view of the image forming apparatus 1.

Herein, a full-color laser beam printer having a plurality of photosensitive drums is described as an example of the image forming apparatus 1. However, the present disclosure is not limited thereto. For example, the present disclosure is also applicable to an image forming apparatus such as a monochrome copying machine, a printer, and a facsimile machine having a single photosensitive drum. Further, a sheet discharge portion having a plurality of sheet stacking portions for stacking sheets on which images are formed by the image forming apparatus is described as an example of the sheet conveyance device.

A cassette 2 that stores recording target sheets such as recording paper is housed in a lower portion of the image forming apparatus 1 in a drawable state. A cassette sheet feeding portion 3 is arranged in a vicinity of an end portion of the cassette 2. Then, a manual sheet feeding portion 4 is arranged on the right side of the image forming apparatus 1. Each of the cassette sheet feeding portion 3 and the manual sheet feeding portion 4 separates sheets one by one, and feeds a sheet to a registration roller 5. A conveyance sensor 200a for detecting passage of the sheet is arranged on a downstream of the registration roller 5 in a sheet conveyance direction. The conveyance sensor 200a is pushed up by the sheet and located at a position indicated by a dotted line in FIG. 1 to detect that the sheet is conveyed correctly.

The image forming apparatus 1 includes an image forming portion 6 serving as an image forming device for forming an image on a sheet. The image forming portion 6 according to the present embodiment includes four image forming stations 6Y, 6M, 6C, and 6K corresponding to respective colors of yellow, magenta, cyan, and black. Photosensitive drums 7Y, 7M, 7C, and 7K serving as image bearing members (hereinafter, collectively referred to as “photosensitive drums 7”) and charging devices 8Y, 8M, 8C, and 8K that uniformly charge the surfaces of the respective photosensitive drums 7 are arranged on the image forming portion 6. Further, a scanner unit 9 that irradiates the photosensitive drums 7 with laser beam based on image information to form electrostatic latent images on the photosensitive drums 7 and development devices 10Y, 10M, 10C, and 10K that apply toner to the electrostatic latent images to develop toner images are arranged on the image forming portion 6. Further, primary transfer portions 12Y, 12M, 12C, and 12K (hereinafter, collectively referred to as “primary transfer portions 12”) for transferring the toner images formed on the photosensitive drums 7 to a transfer belt 11 are arranged on the image forming portion 6. The toner images transferred to the transfer belt 11 at the primary transfer portions 12 in an overlapping manner are transferred to a sheet at a secondary transfer portion 13. Thereafter, the toner image on the sheet is fixed and processed by a fixing device 14. A conveyance sensor 200b is arranged on a downstream of the fixing device 14 in the sheet conveyance direction. The conveyance sensor 200b is pushed up by the sheet and positioned at a position indicated by a dotted line in FIG. 1 to detect that the sheet is conveyed correctly.

Thereafter, the sheet that has passed through the fixing device 14 is conveyed to a sheet discharge portion serving as a sheet conveyance device, and guided to a first discharge roller pair (first discharge portion) 16 or a second discharge roller pair (second discharge portion) 17 arranged on the upper side of the first discharge roller pair 16 by a switchable switching member 15.

In a case where images are to be formed on both sides of the sheet, the sheet that has passed through the fixing device 14 is guided to the second discharge roller pair 17 arranged on the upper side of the first discharge roller pair 16 and on the upper left side of the fixing device 14, by the switching member 15 located at a position indicated by a dotted line in FIG. 1. The sheet conveyed to the second discharge roller pair 17 is inversely conveyed to a two-sided conveyance path 19 by the second discharge roller pair 17. In order to convey the sheet at a shortest distance from the second discharge roller pair 17, the two-sided conveyance path 19 extends toward a lower right side, passes by the outer portion of the fixing device 14 in an arc-like state, and further extends toward the lower side of the image forming apparatus 1. The sheet having passed through the two-sided conveyance path 19 is guided to the registration roller 5 again, conveyed to the first discharge roller pair 16 after passing through the secondary transfer portion 13 and the fixing device 14, and discharged to a first sheet stacking portion 18 by being conveyed by the first discharge roller pair 16.

On the other hand, in a case where an image is to be formed on one side of the sheet, the sheet that has passed through the fixing device 14 is guided to the first discharge roller pair 16 arranged on the upper left side of the fixing device 14 by the switching member 15 located at a position indicated by a solid line in FIG. 1. The sheet guided to the first discharge roller pair 16 is discharged to the first sheet stacking portion 18 by the first discharge roller pair 16. Herein, post-processing such as sorting or stapling of sheets may be executed by forming a conveyance path for conveying the sheets discharged by the first discharge roller pair 16 to a sheet processing apparatus (not illustrated) arranged in a vicinity of the image forming apparatus 1.

A second sheet stacking portion (second stacking portion) 21 positioned on the upper side of the first sheet stacking portion (first stacking portion) 18 is arranged on the downstream side of the second discharge roller pair 17. The second sheet stacking portion 21 includes a rotation support shaft 21a extending in a width direction orthogonal to the sheet conveyance direction at an end portion on the upstream side in the conveyance direction, so that the second sheet stacking portion 21 is rotatably and axially supported thereby at a front side and a rear side of the apparatus main body. A driving gear 31 is coaxially fixed to the end portion of the rotation support shaft 21a on the rear side of the apparatus main body, and the driving gear 31 is coupled to a pinion gear 32 of a driving motor 33.

A sheet on which an image is fixed is conveyed to and stacked on the second sheet stacking portion 21 or the first sheet stacking portion 18 according to an instruction of a user or a control portion. The second sheet stacking portion 21 is located at a home position (second position) illustrated in FIG. 1 if a stacking instruction is not provided thereto. At the home position, the second sheet stacking portion 21 is located at a position not to interrupt conveyance or a stacking property of sheets and the user who accesses the sheets stacked on the first sheet stacking portion 18 when a predetermined number of sheets are stacked on the first sheet stacking portion 18. More specifically, at the home position, the second sheet stacking portion 21 is positioned to have a sheet stacking space between the second sheet stacking portion 21 and the first sheet stacking portion 18. Further, at the home position, in consideration of a distribution efficiency or an issue of breakage during distribution, the second sheet stacking portion 21 is positioned on an inner side of an exterior face line G of the image forming apparatus 1.

On the other hand, if a stacking instruction is issued to the second sheet stacking portion 21, the rotation support shaft 21a is driven and rotated by the driving motor 33 via the pinion gear 32 and the driving gear 31, so that the second sheet stacking portion 21 is moved to a stacking position (first position) from the home position. More specifically, as illustrated in FIG. 2, the second sheet stacking portion 21 is moved to the stacking position at which the second sheet stacking portion 21 is inclined to cause the downstream side thereof in the sheet conveyance direction to be positioned further upward than the home position with respect the upstream side. At the stacking position, a position of the second sheet stacking portion 21 is set in such a manner that a stacking property or user access with respect to the first sheet stacking portion 18 will not be interrupted even if a predetermined number of sheets having a maximum size are discharged and stacked on the second sheet stacking portion 21, and end portions of the sheets on the downstream side pass over a downstream end portion 21b of the second sheet stacking portion 21 to hang down in a direction approaching the first sheet stacking portion 18.

Then, in the present embodiment, regardless of whether the second sheet stacking portion 21 is located at the home position or the stacking position, or is moving between the home position and the stacking position, the second sheet stacking portion 21 will not intercept the conveyance path of the second discharge roller pair 17, and thus conveyance or inversion conveyance of the sheet can be executed by the second discharge roller pair 17.

As described above, the image forming apparatus 1 according to the present embodiment includes the second sheet stacking portion 21 movable to the home position and the stacking position. At the home position, in consideration of a distribution efficiency or breakage of the apparatus main body during distribution, the second sheet stacking portion 21 is positioned on the inner side of the exterior face of the apparatus main body, without interrupting a stacking property and user access with respect to the first sheet stacking portion 18. Further, at the stacking position, even if sheets having a maximum size are stacked on the second sheet stacking portion 21, a stacking property and user access with respect to the first sheet stacking portion 18 will not be interrupted thereby. Then, the second sheet stacking portion 21 can move between the home position and the stacking position even if conveyance operation is being executed by the second discharge roller pair 17, and image forming processing will not be interrupted at any of the above positions. As a result, it is possible to realize a user-friendly compact image forming apparatus which is capable of operating without suspending or delaying the sheet conveyance operation or sheet feeding operation and without lowering the productivity, even in a case where the user uses the image forming apparatus in various ways.

Further, in the above-described embodiment, although the second sheet stacking portion 21 is driven by the driving motor 33, the configuration thereof is not limited thereto. For example, an end portion of the rotation support shaft 21a of the second sheet stacking portion 21 may be extended to the outside of the exterior face of the apparatus, and a lever operable by the user may be coupled thereto instead of providing the driving motor 33. With this configuration, the second sheet stacking portion 21 can be manually moved by the user. In this case, even if the sheets are being conveyed, the user can intentionally move the second sheet stacking portion 21 without causing a jam or operational delay of the image forming apparatus 1, and thus an effect similar to the effect acquired from the configuration using a driving portion 30 can be acquired.

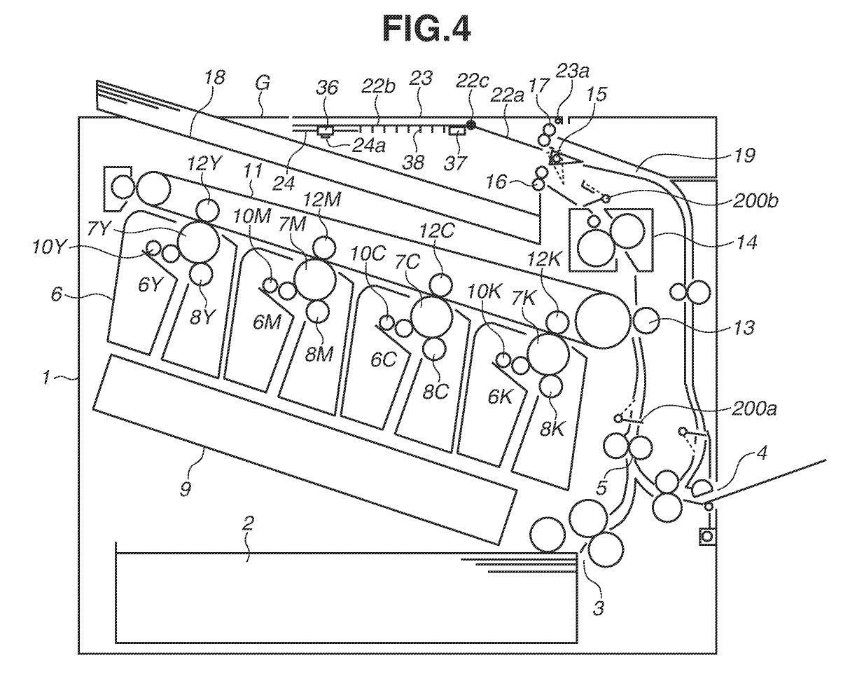

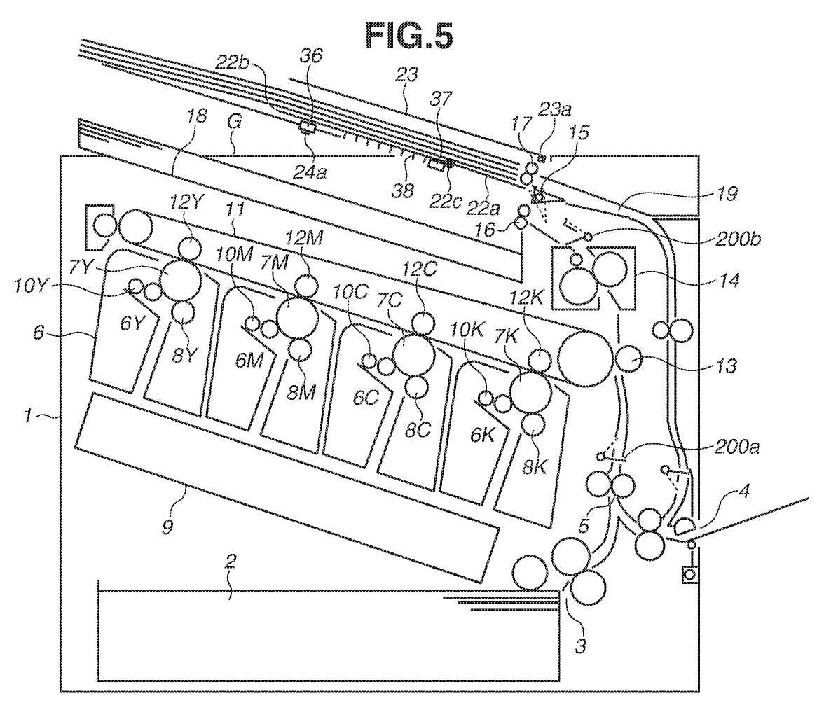

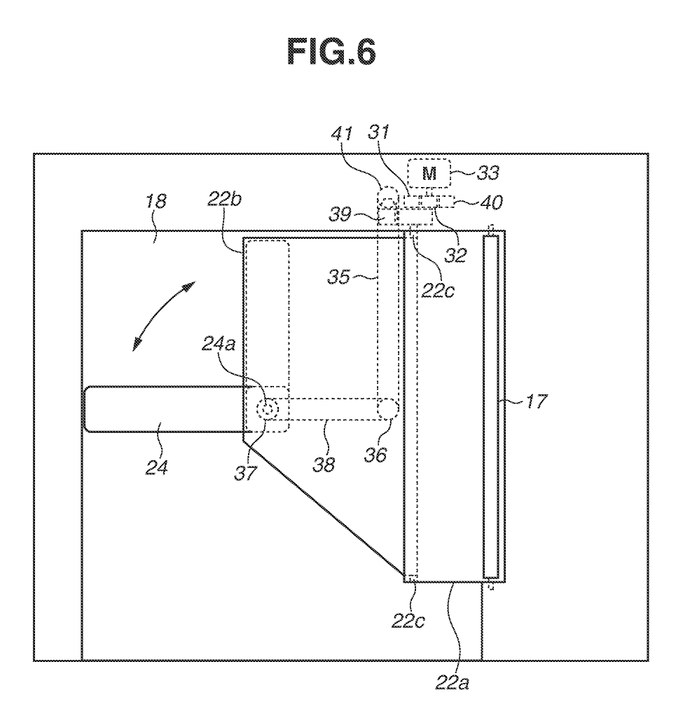

An image forming apparatus including a sheet conveyance device according to a second embodiment will be described with reference to FIGS. 4 to 6. In addition, description of a configuration overlapping the first embodiment will be omitted. FIGS. 4 and 5 are main cross-sectional views illustrating an entire configuration of an image forming apparatus 1 according to the present embodiment. FIG. 6 is a top plan view of the image forming apparatus 1 according to the present embodiment, and a discharged-sheet cover 23 is not illustrated for the convenience of description.

A second sheet stacking portion (second stacking portion) 22 positioned on the upper side of a first sheet stacking portion (first stacking portion) 18 is arranged on the downstream side of a second discharge roller pair 17. The second sheet stacking portion 22 has a two-body structure consisting of a fixed portion 22a on the upstream side and a movable portion 22b on the downstream side in the sheet conveyance direction. The fixed portion 22a on the upstream side is fixed to the image forming apparatus 1. The movable portion 22b on the downstream side is rotatably and axially supported by a rotation support shaft 22c extending in a width direction orthogonal to the sheet conveyance direction with respect to the fixed portion 22a. A driving gear (stepped gear) 31 coupled to a pinion gear of a driving motor 33 is coaxially fixed to the end portion of the rotation support shaft 22c on the rear side of the main body.

Further, an extension tray 24 is arranged on a lower face of the movable portion 22b of the second stacking portion 22. The extension tray 24 is rotatably and axially supported with respect to the movable portion 22b of the second sheet stacking portion 22, by a rotation support point 24a vertically extending to a stacking face of the movable portion 22b of the second sheet stacking portion 22. The extension tray 24 is supported with respect to the movable portion 22b to be movable to a supporting position at which the extension tray 24 supports the sheets projected on a downstream side in the sheet conveyance direction from the movable portion 22b of the second sheet stacking portion 22 at the stacking position in FIG. 5, and a housing position at which the extension tray 24 is housed in the movable portion 22b of the second sheet stacking portion 22 at the home position in FIG. 4. As illustrated in FIG. 6, driving force is transmitted to the extension tray 24 from the driving motor 33 through bevel gears 39 and 41 coupled to the driving gear (stepped gear) 31, a timing belt 35, a pulley 36 and a timing belt 38 arranged on the movable portion 22b of the second sheet stacking portion 21, and a pulley 37 fixed to the extension tray 24. Driving speed is increased by the driving gear (stepped gear) 31, which corresponds to an increase in the moving amount of the extension tray 24 with respect to the movable portion 22b of the second sheet stacking portion 22.

Of the above-described drivetrain, the driving motor 33, the pinion gear 32, the driving gear (stepped gear) 31, and the bevel gears 39 and 41 are positioned on the apparatus main body. As a result, when the movable portion 22b of the second sheet stacking portion 22 is to be moved, driving force is transmitted thereto in a state where the timing belt 35 is twisted between the bevel gear 41 and the pulley 36.

Further, a discharged-sheet cover (cover member) 23 for covering the second discharge roller pair 17 and the second sheet stacking portion 22 is arranged on the upper side of the second sheet stacking portion 22. The discharged-sheet cover 23 is rotatably and axially supported around a rotation support shaft 23a, and an end portion of the rotation support shaft 23a on the rear side of the apparatus main body is coupled to a driving gear 40, so that driving force is transmitted thereto from the driving motor 33.

When sheets are not stacked on the second stacking portion 22, the second sheet stacking portion 22, the discharged-sheet cover 23, and the extension tray 24 are located at the home position (second position) illustrated in FIG. 4. At this time, the discharged-sheet cover 23 forms the same plain face as another exterior face of the apparatus. Further, a gap (first space) which one or more sheets can pass through is provided between the discharged-sheet cover 23 and the second sheet stacking portion 22. Therefore, the second discharge roller pair 17 can also convey sheets to the second sheet stacking portion 22 at the home position.

Further, the discharged-sheet cover 23 covers the second discharge roller pair 17 and the second sheet stacking portion 22 at the home position. Accordingly, the user will not touch the second discharge roller pair 17 by mistake in a driving state, so that the second discharge roller pair 17 is prevented from being soiled. Further, an inversion path can be also prevented from being soiled.

Then, at the home position, the second sheet stacking portion 22 and the extension tray 24 are located at a position not to interrupt conveyance or a stacking property of sheets and the user who accesses the sheets stacked on the first sheet stacking portion 18 when a predetermined number of sheets are stacked on the first sheet stacking portion 18. More specifically, at the home position, the second sheet stacking portion 22 is positioned to have a sheet stacking space between the second sheet stacking portion 22 and the first sheet stacking portion 18.

When the sheets are to be stacked on the second sheet stacking portion 22, the movable portion 22b of the second sheet stacking portion 22, the discharged-sheet cover 23, and the extension tray 24 are driven by the driving motor 33 to move to the stacking position (first position) illustrated in FIG. 5. When the driving gear 31 rotates, the movable portion 22b located on the downstream side of the second sheet stacking portion 22 rotates about the rotation support shaft 22c. Then, the movable portion 22b moves to the stacking position at which the end portion thereof on the downstream side in the sheet conveyance direction is inclined and positioned on the upper side with respect to the rotation support shaft 22c located on the upstream side.

At the same time, the discharged-sheet cover 23 also receives driving force from the driving gear 40 and rotates about the rotation support shaft 23a. Then, as illustrated in FIG. 5, the discharged-sheet cover 23 is moved to the first position, at which a leading end thereof on the downstream side in the sheet conveyance direction is positioned on the upper side of the rotation support shaft 23a on the upstream side, at which a space (second space) wider than the first space for stacking a predetermined number of sheets is provided on the upper side of the second sheet stacking portion 22. At this time, the driving gear 31 of the second sheet stacking portion 22 and the driving gear 40 of the discharged-sheet cover 23 are coupled to each other via the pinion gear 32. Thus, movement of the movable portion 22b of the second sheet stacking portion 22 and movement of the discharged-sheet cover 23 are synchronized with each other. Then, in order to make the second sheet stacking portion 22 and the discharged-sheet cover 23 stay a certain distance away from each other, the position of the rotation support shaft 23a of the discharged-sheet cover 23 is set to a position on the upstream side in the conveyance direction with respect to the rotation support shaft 22c of the movable portion 22b on the downstream side of the second sheet stacking portion 22. Alternatively, as a method of making the second sheet stacking portion 22 and the discharged-sheet cover 23 stay a certain distance away from each other, there is also provided a method in which an operation timing is shifted therebetween through a setting of the drivetrain.

Further, as illustrated in FIG. 6, the extension tray 24 having a long thin plate shape, which is arranged on a lower face of the movable portion 22b of the second sheet stacking portion 22, is driven by the driving motor 33 via the bevel gears 39 and 41, and the timing belt 38 to rotate about a rotation support point 24a by 90-degree, and moved to the stacking position (i.e., a first position expressed by a solid line) from the home position (i.e., a second position expressed by a dotted line). At this time, the movable portion 22b and the extension tray 24 of the second sheet stacking portion 22 move in synchronization with each other because driving thereof is coupled to each other. Thus, like the movable portion 22b of the second sheet stacking portion 22 moves away from the first sheet stacking portion 18, the extension tray 24 also moves so as not to have an influence on the first sheet stacking portion 18.

When sheets having the maximum size are discharged and stacked on the second sheet stacking portion 22 at the stacking position, the extension tray 24 supports the leading ends of the sheets in order not to interrupt a stacking property or user access with respect to the first sheet stacking portion 18. By providing the extension tray 24, at the home position, a length of the second sheet stacking portion 22 in the sheet conveyance direction can be shorter than that of the first embodiment. As a result, the user can access the first sheet stacking portion 18 more easily, and downsizing of the image forming apparatus 1 can be also achieved.

Further, at the stacking position, a length of the second sheet stacking portion 22 including the extension tray 24 in the sheet conveyance direction can be longer than that of the first embodiment, so that an amount of the leading end of the sheet having a maximum size projecting therefrom can be reduced. As a result, even if inclination of the second sheet stacking portion 22 is set to be reduced, the first sheet stacking portion 18 will not be interrupted thereby. Accordingly, a space height occupied by the entire apparatus when the sheets are stacked on the second sheet stacking portion 22 can be reduced.

As described above, with the image forming apparatus 1 according to the present embodiment, erroneous user operation can be prevented by arranging the discharged-sheet cover 23 on the first sheet stacking portion 18, and a space occupied by the entire apparatus can be reduced by arranging the extension tray 24. Therefore, it is possible to realize a space-saving compact image forming apparatus capable of preventing lowering of the productivity caused by, for example, suspending or delaying the conveyance operation or the sheet feeding operation of transfer materials, and the image forming apparatus further can reduce the possibility of erroneous user operation, even in a case where the user uses the image forming apparatus in various ways.

Further, in the present embodiment, although the image forming apparatus 1 provided with both of the discharged-sheet cover 23 and the extension tray 24 has been described as an example, each of the effects corresponding thereto can be added to an image forming apparatus if any one of the discharge cover and the extension tray is provided.

Further, although the movable portion 22b provided with the driving motor 33 as a driving source has been described as an example, a configuration thereof is not limited thereto. Similar to the configuration described in the first embodiment, the rotation support shaft 22c may be coupled to a lever operable by the user, and the second sheet stacking portion 22, the extension tray 24, and the discharged-sheet cover 23 can be manually moved by the user, so that the effect similar to the above-described effect can be acquired.

In the present embodiment, although the discharged-sheet cover 23 and the extension tray 24 move in synchronization with each other by coupling the movable portion 22b of the second sheet stacking portion 22 with the respective gears 31, 32, 39, 41, and 40, the pulleys 36 and 37, and the timing belts 35 and 38, the present embodiment is not limited thereto, and any configuration is possible as long as a conveyance path between the discharged-sheet cover 23 and the second sheet stacking portion 22 is ensured, while the extension tray 24 does not exert an influence on the first sheet stacking portion 18. Further, in the present embodiment, although the discharged-sheet cover 23, the extension tray 24, and the movable portion 22b of the second sheet stacking portion 22 are rotated and moved by the rotation support shaft 23a, 24a, or 22c, another moving method such as a slide-moving method may be also used.

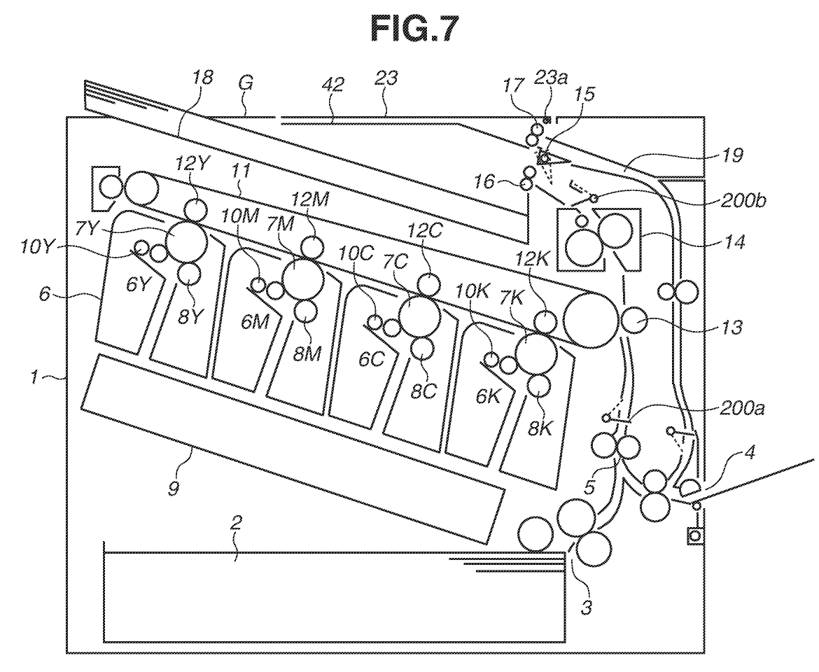

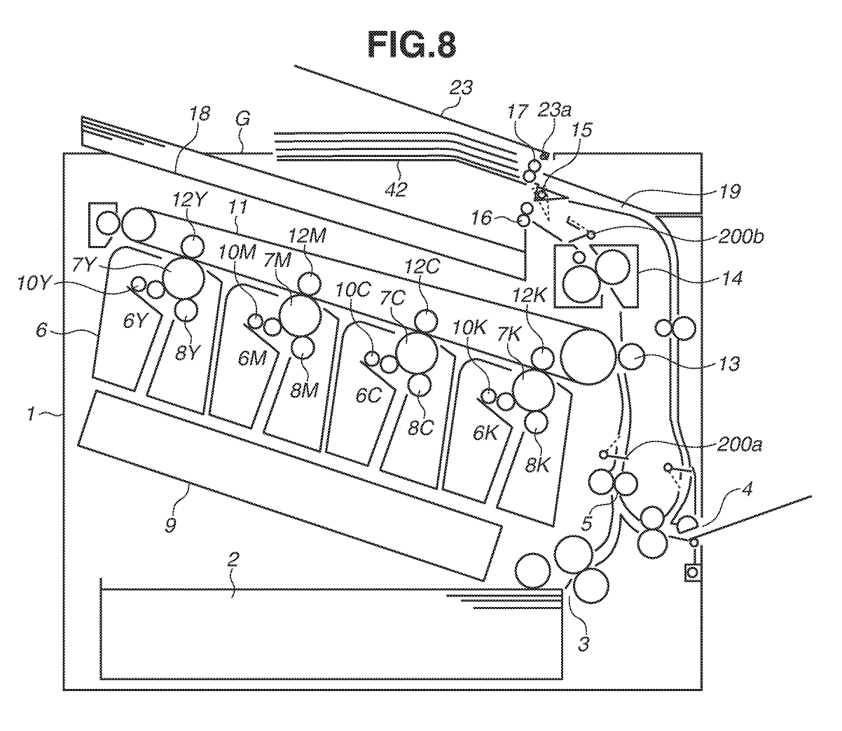

An image forming apparatus including a sheet conveyance device according to a third embodiment will be described with reference to FIGS. 7 and 8. In addition, description of a configuration overlapping the first or the second embodiment will be omitted. FIGS. 7 and 8 are main cross-sectional views illustrating an entire configuration of an image forming apparatus 1 according to the present embodiment.

In FIGS. 7 and 8, a second sheet stacking portion 42 positioned on the upper side of a first sheet stacking portion 18 is fixed to the image forming apparatus 1. On the upper side of the fixed second sheet stacking portion 42, a discharged-sheet cover (cover member) 23 is arranged to be rotatable about a rotation support shaft 23a.

When sheets are not stacked on the second sheet stacking portion 42, the discharged-sheet cover 23 is located at a home position (second position) illustrated in FIG. 7. At this time, the discharged-sheet cover 23 forms the same plain face as another exterior face of the apparatus. Further, a gap (first space) which one or more sheets can pass through is provided between the discharged-sheet cover 23 and the second sheet stacking portion 42.

At the home position, the second sheet stacking portion 42 is located at a position not to interrupt conveyance or a stacking property of sheets and the user who accesses the sheets stacked on the first sheet stacking portion 18 when a predetermined number of sheets are stacked on the first sheet stacking portion 18. In other words, at the home position, the second sheet stacking portion 42 is positioned to have a sheet stacking space between the second sheet stacking portion 42 and the first sheet stacking portion 18. Further, at the home position, in consideration of distribution efficiency and an issue of breakage during distribution, the discharged-sheet cover 23 forms the same plain face as another exterior face.

When the sheets are to be stacked on the second sheet stacking portion 42, the discharged-sheet cover 23 moves to a stacking position (first position) illustrated in FIG. 8. In the present embodiment, although the second sheet stacking portion 42 is fixed and immovable, a space (second space) between the second sheet stacking portion 42 and the discharged-sheet cover 23 at the stacking position is wider than the above-described first space, so that a predetermined number of sheets can be stacked thereon.

As described above, the image forming apparatus 1 according to the present embodiment includes the discharged-sheet cover 23 movable to the second and the first positions. Then, at the home position, in consideration of distribution efficiency or an issue of breakage of the apparatus main body during distribution, the discharged-sheet cover 23 is positioned on the inner side of the apparatus main body. Further, at the stacking position, the discharged-sheet cover 23 is moved to allow sheets to be stacked on the fixed second sheet stacking portion 42. The discharged-sheet cover 23 is movable between the home position and the stacking position even if conveyance operation is being executed by the second discharge roller pair 17, and image forming operation will not be interrupted thereby at any of the positions. In other words, it is possible to realize a user-friendly compact image forming apparatus capable of operating without lowering the productivity caused by, for example, suspending or delaying the sheet conveyance operation or sheet feeding operation or without, even in a case where the user uses the image forming apparatus in various ways.

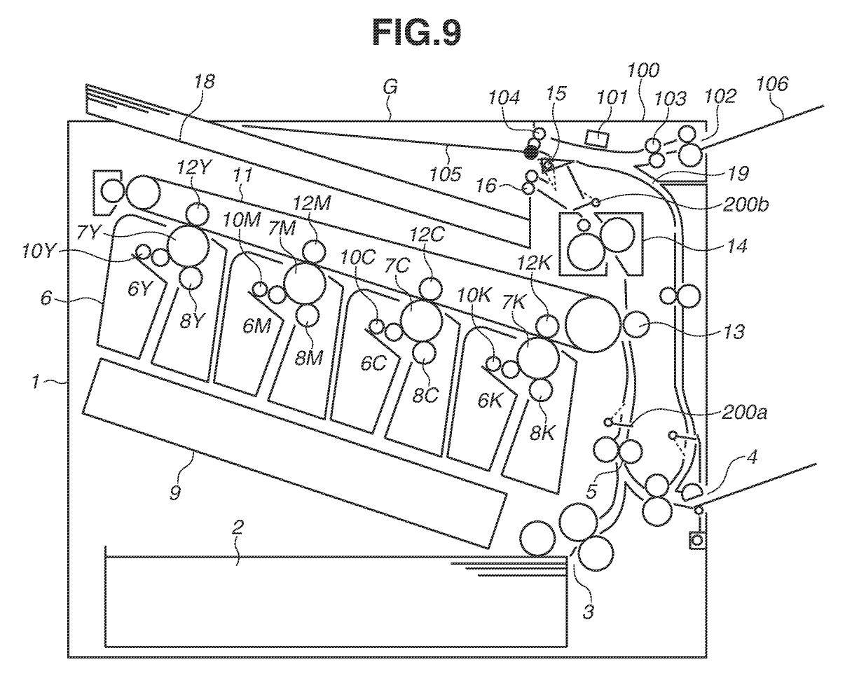

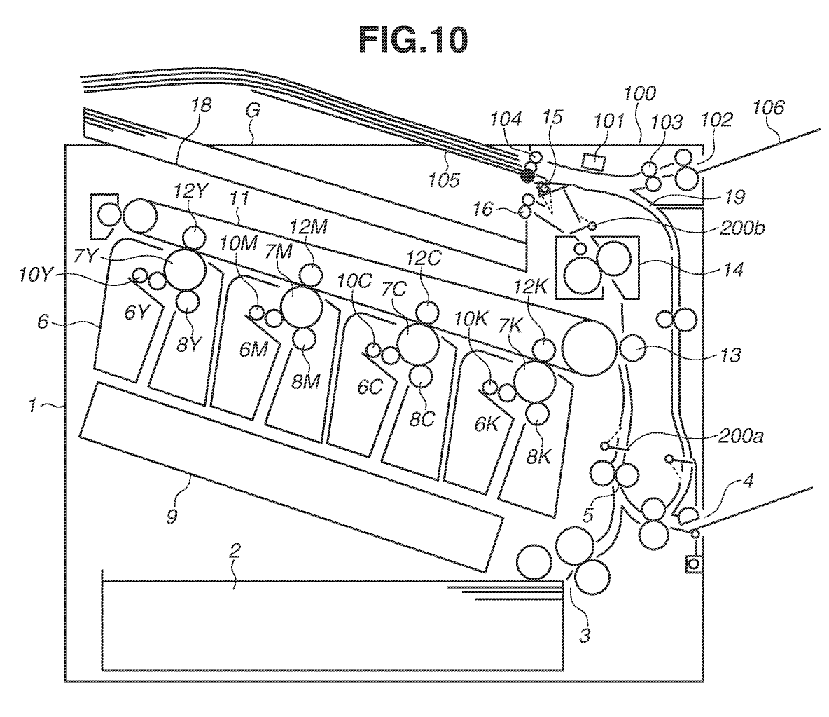

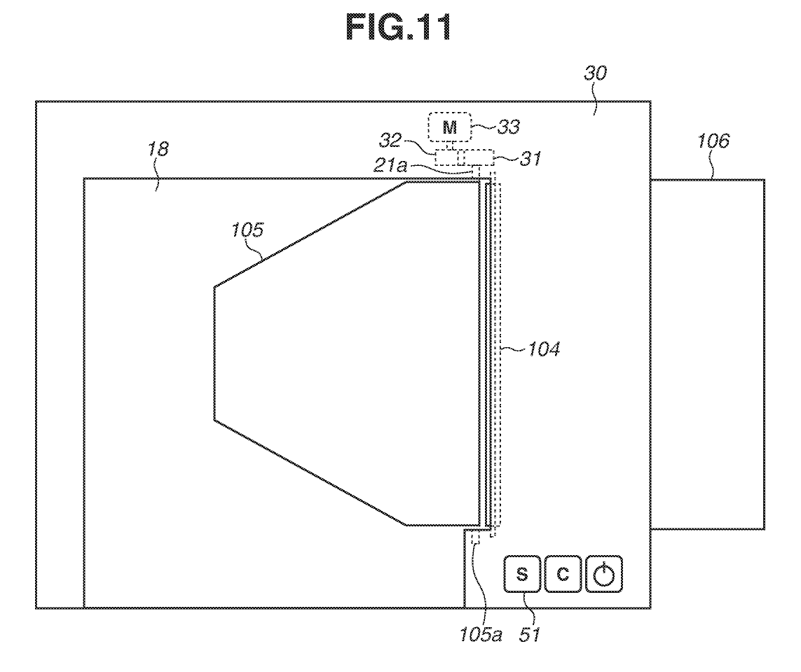

An image forming apparatus including a sheet conveyance device according to a fourth embodiment will be described with reference to FIGS. 9 to 11. In addition, description of a configuration overlapping that of the first, the second, or the third embodiment will be omitted. FIGS. 9 and 10 are main cross-sectional views illustrating an entire configuration of an image forming apparatus 1 according to the present embodiment. FIG. 11 is a top plan view of the image forming apparatus 1 according to the present embodiment.

As illustrated in FIG. 9, the image forming apparatus 1 includes an image reading portion 100 for reading an image of a document, which is arranged on the upper side of the image forming portion 6. The image reading portion 100 is arranged on the upper side of the fixing device 14 included in the image forming apparatus 1. The image reading portion 100 includes an image reading unit 101 for reading an image of a document as a reading target sheet. Documents as reading target sheets placed on a document setting portion 106 are separated one by one and fed to a document registration roller 103 by a document feeding roller 102. A document fed to the document registration roller 103 is conveyed to the image reading unit 101, so that an image of a document is read thereby while being conveyed and passing through the image reading unit 101 arranged on an upper face side thereof. Then, the document of which image has been read is conveyed to a document discharge roller pair 104 and discharged to a document stacking portion 105 by the document discharge roller pair 104.

The document discharge roller pair 104 can discharge and inversely convey a sheet conveyed from the fixing device 14 in addition to discharging a document. The sheet conveyed from the fixing device 14 can be also stacked on the document stacking portion 105 in addition to the document of which image has been read. In other words, the document discharge roller pair 104 functions as a second discharge portion for discharging a reading target sheet such as a document or a recording target sheet such as a recording sheet. Further, the document stacking portion 105 is arranged on the upper side of the first sheet stacking portion 18 and functions as a second stacking portion on which the sheet discharged by the document discharge roller pair 104 is stacked.

With respect to the image forming apparatus 1, the document stacking portion 105 can move to two positions, i.e., a home position (second position) illustrated in FIG. 9, at which a reading target sheet such as a document or a recording target sheet such as a recording sheet is not stacked, and a stacking position (first position) illustrated in FIG. 10, at which the sheet is stacked thereon. The document stacking portion 105 can move between the home position and the stacking position while the document discharge roller pair 104 is conveying a document or a sheet. For example, an image formed by the image forming portion 6 is fixed to a sheet, so that the sheet is inverted and being conveyed to the two-sided conveyance path 19 by the document discharge roller pair 14 after passing through the fixing device 14. In this state, if the user who would like to scan a document presses a scan button 51 (see FIG. 11) provided on the upper side of the apparatus main body, the document stacking portion 105 can be moved to a stackable position while the inversion conveyance is being executed, and thus the user can prepare for scanning operation. Therefore, reading of the image can be started immediately after the sheet has passed therethrough.

Image data read by the image reading unit 101 is stored in a computer on the network as electronic data, or converted into print data by the control portion and copied to a new sheet.

As described above, in the image forming apparatus 1 according to the present embodiment, the second sheet stacking portion can also serve as a document setting portion, and the user can prepare for document reading operation even if printing operation is being executed by the apparatus main body. Therefore, waiting time of the user can be reduced, and operation efficiency can be refined.

### Other Embodiment

In the above-described embodiments, a printer has been described as an example of the image forming apparatus. However, the present disclosure is not limited thereto. For example, the image forming apparatus may be another image forming apparatus such as a copying machine or a facsimile machine, or still another image forming apparatus such as a multifunction peripheral in which functions of the copying machine and the facsimile machine are combined together. The same effect can be acquired by applying the present disclosure to the sheet conveyance device used for the above-described image forming apparatus.

Further, in the above-described embodiment, although an image forming apparatus having an image forming portion or an image forming apparatus having an image forming portion and an image reading unit has been described as an example, the present disclosure is not limited thereto. For example, the image forming apparatus may be an image reading apparatus such as a scanner apparatus having an image reading unit for reading an image of a reading target sheet such as a document. The same effect can be acquired by applying the present disclosure to a sheet conveyance device which conveys a reading target sheet such as a document, which is used for the image reading apparatus.

Further, in the above-described embodiments, although a sheet conveyance portion (sheet discharge portion) for conveying a recording target sheet such as a recording sheet on which an image is formed has been described as an example of the sheet conveyance device, the present disclosure is not limited thereto. For example, the same effect can be acquired by applying the present disclosure to a sheet conveyance device which conveys a reading target sheet such as a document.

According to the present disclosure, it is possible to prevent lowering of productivity while achieving downsizing of the apparatus without causing operation delay of the apparatus or occurrence of a jam.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2017-070096, filed Mar. 31, 2017, which is hereby incorporated by reference herein in its entirety.

What is claimed is:

1. A sheet conveyance device comprising:
a first discharge portion configured to discharge sheets;
a first stacking portion on which sheets discharged from the first discharge portion are to be stacked;
a second stacking portion arranged on an upper side of the first discharge portion, on which sheets are to be stacked;
a second discharge portion configured to discharge sheets to the second stacking portion; and
a control unit configured to control the second stacking portion to move between a first position and a second position,
wherein the first position is that a downstream side of the second stacking portion is positioned and inclined upwardly with respect to an upstream side of the second stacking portion in a sheet conveyance direction of the sheets discharged from the second discharge portion, and
wherein the second position is that the downstream side of the second stacking portion is positioned on a lower side of the first position of the downstream side of the second stacking portion.

2. The sheet conveyance device according to claim 1, wherein the second stacking portion includes an extension tray movable between a supporting position at which the extension tray supports the sheets projecting on a downstream side in the sheet conveyance direction from the second stacking portion at the first position and a housing position at which the extension tray is housed in the second stacking portion at the second position.

3. The sheet conveyance device according to claim 1 further comprising a cover member arranged on an upper side of the second stacking portion and configured to cover the second discharge portion and the second stacking portion,
wherein, in a case where the second stacking portion is positioned at the second position, the cover member has a first space between the cover member and the second stacking portion, and
wherein, in synchronization with movement of the second stacking portion from the second position to the first position, the cover member moves to a position at which the cover member is inclined to cause a downstream side of the sheets in the sheet conveyance direction to be positioned on an upper side of an upstream side of the sheets to have a second space wider than the first space between the cover member and the second stacking portion.

4. The sheet conveyance device according to claim 3, wherein, at the second position, the cover member forms a plain face that is the same as an exterior face of an apparatus.

5. The sheet conveyance device according to claim 1, wherein the second stacking portion has a two-body structure consisting of a fixed portion on the upstream side fixed to an apparatus in the sheet conveyance direction, and a movable portion on the downstream side supported to be movable between the second position and the first position with respect to the fixed portion.

6. The sheet conveyance device according to claim 1, further comprising a switching member configured to guide the sheets to the first discharge portion or the second discharge portion.

7. The sheet conveyance device according to claim 1, wherein the second discharge portion is configured to perform inversion conveyance.

8. A sheet conveyance device comprising:
a first discharge portion configured to discharge sheets;
a first stacking portion on which sheets discharged from the first discharge portion are to be stacked;
a second stacking portion arranged on an upper side of the first discharge portion, on which sheets are to be stacked;
a second discharge portion configured to discharge sheets to the second stacking portion; and
a cover member positioned on an upper side of the second discharge portion and configured to cover the second discharge portion and the second stacking portion,
wherein the cover member is arranged to be movable between a second position and a first position, and
wherein, at the first position, a downstream side of the cover member in a sheet conveyance direction of the sheets discharged from the second discharge portion is positioned on an upper side of the second position.

9. The sheet conveyance device according to claim 8, wherein, at the second position, the cover member forms a plain face that is the same as an exterior face of an apparatus.

10. The sheet conveyance device according to claim 8 further comprising a control portion configured to control the cover member to move between the first position and the second position.

11. An image forming apparatus comprising:
an image forming unit configured to form an image on a sheet; and
the sheet conveyance device according to claim 1.

12. An image forming apparatus comprising:
the sheet conveyance device according to claim 1; and
an image reading unit configured to read an image of a document,
wherein a document of which an image is read by the image reading unit is discharged by the second discharge portion and stacked on the second stacking portion.

13. An image reading apparatus comprising:
an image reading unit configured to read an image of a document; and
the sheet conveyance device according to claim 1.

14. An image forming apparatus comprising:
an image forming unit configured to form an image on a sheet; and
the sheet conveyance device according to claim 6.

15. An image forming apparatus comprising:
the sheet conveyance device according to claim 6; and
an image reading unit configured to read an image of a document,
wherein a document of which an image is read by the image reading unit is discharged by the second discharge portion and stacked on the second stacking portion.

16. An image reading apparatus comprising:
an image reading unit configured to read an image of a document; and
the sheet conveyance device according to claim 6.
